(19) United States
(12) Patent Application Publication
(10) Pub. No.: US 2015/0281249 A1
(43) Pub. Date: Oct. 1, 2015

(54) ACCOUNT GENERATING METHOD, APPARATUS, AND SYSTEM

(71) Applicant: Tencent Technology (Shenzhen) Company Limited, Shenzhen, Guangdong (CN)

(72) Inventor: Lihua Huang, Shenzhen City (CN)

(21) Appl. No.: 14/437,447

(22) PCT Filed: Sep. 24, 2013
(86) PCT No.: PCT/CN2013/084054

§ 371 Date: Apr. 21, 2015

(30) Foreign Application Priority Data
Oct. 22, 2012 (CN) 201210403967.5

(51) Int. Cl. H04L 29/06

(52) U.S. Cl. CPC H04L 63/102; H04L 63/101

(57) ABSTRACT

Implementation manners of the present disclosure provide an account generating method, apparatus, and system. The method includes: receiving, by one of at least two account service processes, an account registration request that includes registration information; and obtaining, by the account service process that receives the account registration request, the registration information by parsing the account registration request, and generating an account that corresponds to the registration information. The implementation manners of the present disclosure significantly improve account management stability. The implementation manners of the present disclosure can also be applied to various terminal entities, and the implementation manners of the present disclosure are widely applicable as can be used in a cross-platform and cross-terminal manner.

### RELATED APPLICATION

This application is the U.S. National Phase application under 35 U.S.C. 371 of PCT/CN2013/084054, filed on Sep. 24, 2013 and published in Chinese as WO 2014/063551 on May 1, 2014. This application claims priority to Chinese Patent Application No. 201210403967.5, filed with the Chinese Patent Office on Oct. 22, 2012 and entitled “ACCOUNT GENERATING METHOD, APPARATUS, AND SYSTEM”. The entire disclosures of the above applications are incorporated herein by reference in their entirety.

### FIELD OF THE TECHNOLOGY

Implementation manners of the present disclosure relate to the field of account management technologies, and in particular, to an account generating method, apparatus, and system.

### BACKGROUND OF THE DISCLOSURE

In the current information era, various information devices emerge as the times require, such as a fixed-line phone and a mobile phone that are used for voice transmission, or a server and a personal computer that are used for information resource sharing and processing, or various televisions used for displaying video data. These devices emerge in specific fields for addressing actual requirements. With the convergence of electronic consumption, computers, and communication (3C), people pay increasing attention to researches on comprehensive utilization of information devices of different fields, so as to fully utilize existing resources and devices to better serve people.

Account management is an application commonly seen in the various information devices. An account is a record saved in a network and a multi-user operating system, and is used to record behaviors of an authorized user. A network account is generally created by a network administrator, used to verify a user and manage policies related to each user, such as access permission. As a representative of the digital age, the account is some numbers or the like representing a user in a specific project. The account sometimes may be formed by Chinese characters or English letters, or even some symbols.

In an existing account generating method, an account allocation subsystem is in charge of generating accounts, and a business service subsystem is in charge of storing and accessing account information. When a user initiates an account registration request, the account allocation subsystem generates a unique account for the user, and then the business service subsystem stores the account and registration information.

However, in such an account generating method, an account allocation subsystem allocates accounts, and therefore, the account allocation subsystem easily becomes a single point in a whole set of services. Once the account allocation subsystem breaks down, an entire registration service is unavailable; therefore, such an account generating method is not stable.

In addition, in such an account generating method, an account allocation function is achieved by a single account allocation subsystem, thereby increasing costs of development of the account allocation subsystem, later period operation and maintenance, and devices. Moreover, when and only when the account allocation subsystem and the business service subsystem are both available, the registration service is available; therefore, the entire account registration service has low availability.

### SUMMARY

Implementation manners of the present disclosure provide an account generating method, thereby improving account management stability.

The implementation manners of the present disclosure further provide an account generating apparatus, thereby improving account management stability.

The implementation manners of the present disclosure further provide an account generating system, thereby improving account management stability.

The implementation manners have the following specific solutions:

An account generating method includes:

receiving, by one of at least two account service processes, an account registration request that includes registration information; and

obtaining, by the account service process that receives the account registration request, the registration information by parsing the account registration request, and generating an account that corresponds to the registration information;

storing the registration information in a local file, wherein

the generating an account that corresponds to the registration information comprises:

generating, by using a number of the local file and a storage offset, which is in the local file, of the registration information, an account that corresponds to the registration information.

An account generating apparatus includes: a registration information parsing unit and an account generating unit:

the registration information parsing unit being configured to obtain, by using one account service process that receives an account registration request in at least two account service processes, registration information by parsing the account registration request; and

the account generating unit being configured to generate an account that corresponds to the registration information; wherein

the registration information parsing unit is further configured to store the registration information in a local file; and

the account generating unit is further configured to generate, by using a number of the local file and a storage offset, which is in the local file, of the registration information, the account that corresponds to the registration information.

An account generating system includes an account request sending apparatus and an account generating apparatus:

the account request sending apparatus being configured to send an account registration request that includes registration information to the account generating apparatus; and

the account generating apparatus being configured to receive the account registration request that includes the registration information, route the account registration request to one of at least two account service processes, obtain, by using an account service process that receives the account registration request, the registration information by parsing the account registration request, and generate an account that corresponds to the registration information; wherein

the account generating apparatus is further configured to store the registration information in a local file, and generate, by using a number of the local file and a storage offset, which is in the local file, of the registration information, the account that corresponds to the registration information.

It can be seen from the foregoing technical solutions that in the implementation manners of the present disclosure, one of at least two account service processes receives an account registration request that includes registration information; and the account service process that receives the account registration request obtains the registration information by parsing the account registration request, and generates an account that corresponds to the registration information. As can be seen, after the implementation manners of the present disclosure are applied, instead of enabling a single account allocation subsystem to be in charge of allocating accounts, multiple (at least two) account service processes used for account generation are set; in this way, even though an account service process breaks down, other account service processes can continue to provide an account generating service for a user without being affected. Therefore, an entire account registration service is not stopped, and such an account generating manner provided in the implementation manners of the present disclosure significantly improves account management stability.

### BRIEF DESCRIPTION OF THE DRAWINGS

To describe the technical solutions in the embodiments of the present invention or in the existing technology more clearly, the following briefly introduces the accompanying drawings required for describing the embodiments or the existing technology. Apparently, the accompanying drawings in the following description show merely some embodiments of the present invention, and a person of ordinary skill in the art may still derive other drawings from these accompanying drawings without creative efforts.

FIG. 1 is a schematic architectural diagram of an account generating system according to an implementation manner of the present disclosure;

FIG. 2 is a schematic flowchart of an account generating method according to an implementation manner of the present disclosure;

FIG. 3 is a schematic structural diagram of an account generating system according to an implementation manner of the present disclosure;

FIG. 4 is a schematic structural diagram of a first account generating apparatus according to an implementation manner of the present disclosure;

FIG. 5 is a schematic structural diagram of a second account generating apparatus according to an implementation manner of the present disclosure; and

FIG. 6 is a schematic structural diagram of a third account generating apparatus according to an implementation manner of the present disclosure.

### DESCRIPTION OF EMBODIMENTS

To make the technical solutions and advantages of the present disclosure clearer, the following further describes the present disclosure in detail with reference to the accompanying drawings.

Generally, an existing account generating platform includes an account allocation subsystem and a business service subsystem, where the account allocation subsystem is responsible for generating all accounts, and the business service subsystem is in charge of account storage and an access service.

The business service subsystem may specifically include multiple business service processes. When a user initiates an account registration request, a service adapter forwards the account registration request to the account allocation subsystem, the account allocation subsystem generates a unique account for the user, and a business service process in the business service subsystem specifically stores the generated account and related registration information.

As can be seen, in such an account generating manner, a single account allocation subsystem is in charge of generating accounts, and therefore, the account allocation subsystem easily becomes a single point in a whole set of services. Once the account allocation subsystem breaks down, an entire registration service is unavailable; therefore, such an account generating method has a disadvantage of low stability.

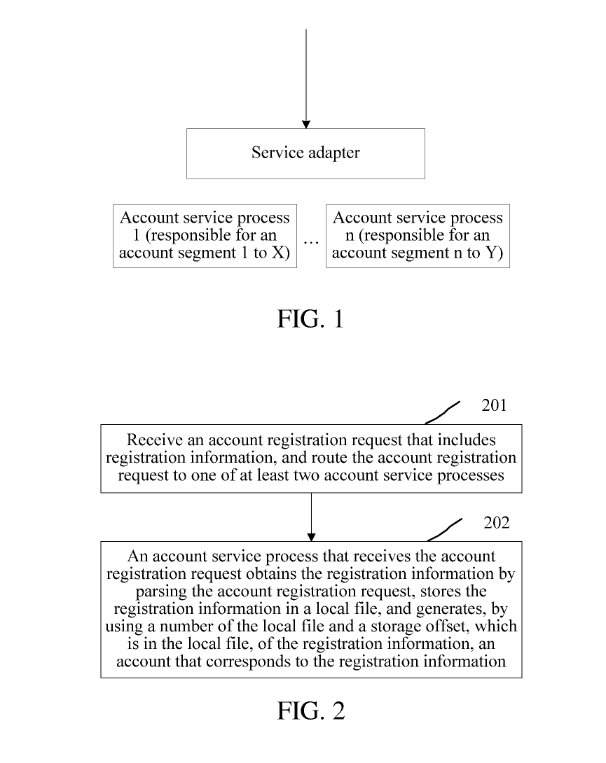

In implementation manners of the present disclosure, a file-based account generating manner is provided. FIG. 1 is a schematic diagram of an account generating manner according to an implementation manner of the present disclosure.

In this implementation manner of the present disclosure, instead of enabling a single account allocation subsystem to be in charge of allocating accounts, multiple (at least two) account service processes used for account generation are set; in this way, even though an account service process breaks down, other account service processes can continue to provide an account generating service without being affected. Therefore, an entire account registration service is not stopped, and such an account generating manner in this implementation manner of the present disclosure significantly improves account management stability.

It can be seen from FIG. 1 that when a user applies for registering an account, one of at least two account service processes receives an account registration request that includes registration information. The account service process that receives the account registration request obtains the registration information by parsing the account registration request, and generates an account that corresponds to the registration information.

The following describes the account generating method of this implementation manner of the present disclosure in more details with reference to a flowchart.

FIG. 2 is a flowchart of an account generating method according to an implementation manner of the present disclosure.

As shown in FIG. 2, the method includes:

Step 201: Receive an account registration request that includes registration information, and route the account registration request to one of at least two account service processes.

Preferably, a same adapter may receive an account registration request initiated by a user, a network application, or any other entity. The account registration request received by the adapter may carry registration information. The registration information may specifically include a user name, a nickname, sex, a home address, a telephone number, a self introduction, a marital status, a working unit, an e-mail address, a note, and the like, or may further include an avatar, an audio self-introduction, and the like.

Herein, after receiving the account registration request, the adapter may route the account registration request to one of at least two account service processes in multiple manners. For example, the adapter routes the account registration request to one of the at least two account service processes in a polling manner.

In the polling manner, each account service process non-competitively receives account registration requests, and generally, the account registration requests are allocated in an ID order of the account service processes. For example, an account registration request received for the first time is allocated to the first account service process; an account registration request received for the second time is allocated to the second account service process; an account registration request received for the third time is allocated to the third account service process; an account registration request received for the fourth time is allocated to the fourth account service process, and the like.

Preferably, each account service process may also competitively receive account registration requests. For example, a priority of each account service process is preset, and the account registration requests are routed to one of at least two account service processes according to an order of the priorities.

In a priority manner, each account service process competitively receives account registration requests. Generally, the account registration requests are allocated according to the order of the priorities of the account service processes, and when a high-priority account service process reaches a service capacity upper limit, the account registration request is sent to a next-priority account service process. For example, it is assumed that a priority of the first account service process is the first priority, a priority of the second account service process is the second priority, and a priority of the third account service process is the third priority. An account registration request received for the first time is sent to the first account service process; and an account registration request received for the second time is sent to the first account service process. When the first account service process reaches the service capacity upper limit, a subsequent account registration request is sent to a next-priority account service process (that is, the second account service process).

Step 202: An account service process that receives the account registration request obtains the registration information by parsing the account registration request, stores the registration information in a local file, and generates, by using a number of the local file and a storage offset, which is in the local file, of the registration information, an account that corresponds to the registration information.

Herein, at least two local files are saved in the account service process that receives the account registration request. A number may be preset for each local file, and preferably, local file numbers are set in an order of Arabic numerals. For example, a numbering sequence of local files is: 1, 2, 3, 4, and the like. The number of each local file may be set as an ID of the local file. For example, if a local file is a text file, the first numbered local file is 1.txt, the second numbered local file is 2.txt, the third numbered local file is 3.txt, and the like.

The account service process that receives the account registration request determines whether storage capacity of a current local file reaches a preset storage upper limit, if yes, stores the registration information in a local file that corresponds to a next local file number, and if not, stores the registration information in a local file that corresponds to a current local file number.

Preferably, a first composition position and a second composition position of an account may be preset. The first composition position is then filled with the number of the local file, and the second composition position is filled with the storage offset, which is in the local file, of the registration information; and the first composition position after filling and the second composition position after filling are combined into the account that corresponds to the registration information.

In an implementation manner, the registration information and the account that corresponds to the registration information are stored in a cache of the account service process; and then it is determined whether an account reading request is received, and if yes, in response to the account reading request, the account that corresponds to the registration information and/or the registration information is extracted from the cache of the account service process, and the account that corresponds to the registration information and/or the registration information is sent.

Preferably, the local files are text files, and each text file has same storage capacity.

Specifically, after receiving the account registration request, the account service process that receives the account registration request may store, in a local file, the registration information in the account registration request, and generates an account of a user by using a file number of a current file and a storage offset, which is in the file, of the registration information. In this way, the account includes a storage location of the registration information, thereby making it convenient to provide a routing service according to an account when a reading service is provided. Preferably, each account file is set to store a same quantity of accounts. In addition, after storing the registration information in the local file, and generating an account, the account service process may temporarily store the account and the registration information in a local cache, so that a reading service can be externally provided rapidly.

The following describes the account generating method of this implementation manner of the present disclosure by using a specific instance. In this instance, it is assumed that an account of 32 bits is expected to be generated, where the account is a 4-byte integer, where high-order 16 bits indicate a file account, and low-order 16 bits indicate a file offset. In a same file, an account is allocated according to the file offset. Preferably, one file has one account segment, which facilitates control of account allocation. To overcome a file performance bottleneck and improve an access speed, TLV storage may further be introduced in this implementation manner of the present disclosure, which can conveniently extend a new field.

After receiving an account registration request sent by a user, an adapter first polls optional account service processes. It is assumed that an account service process 3 is polled, and then the adapter forwards the account registration request to the account service process 3.

After receiving the account registration request, the account service process 3 first obtains registration information by parsing the account registration request, and queries which file is currently written. If the 100^{th} file is written, the account service process 3 reads file header content of first 1 k bytes of a file 100 (100 is a number of the file), and reads a parameter that indicates how much registration information has been written before the file 100 from the file header.

It is assumed that 10 pieces of registration information is written in the file 100, and it may be assumed that 4 k-byte space is fixedly allocated to each piece of registration information; therefore, an offset location of a file to which a current new piece of registration information should be written is: 1 k file header+4 k*10=41 k, that is, the new piece of registration information is written to a starting location of 41 k of the file 100.

When the registration information is successfully written, the account of 32 bits that corresponds to the registration information is generated, where the first 16 bits indicate the number of the file, that is, 100 (0X64 in the hexadecimal system); and the latter 16 bits indicate the file offset 41k (A400 in the hexadecimal system).

A finally generated account is: (100<<16) 1 (41984)=6595584. After the account is generated, the account is returned to a caller.

As can be seen, in this implementation manner of the present disclosure, instead of enabling a single account allocation subsystem to be in charge of allocating accounts, multiple (at least two) account service processes used for account generation are set; in this way, even though an account service process breaks down, other account service processes can continue to provide an account generating service without being affected. Therefore, an entire account registration service is not stopped, and such an account generating manner in this implementation manner of the present disclosure significantly improves account management stability.

In addition, this implementation manner of the present disclosure is simply designed, account service processes are independent of each other, and after a process or machine breaks down, a registration service can still be externally provided by using other processes or machines; therefore, this implementation manner of the present disclosure further improves availability of an account service. In addition, from the perspective of either devices or operation and maintenance, an operation cost of this implementation manner is relatively low.

Moreover, this implementation manner of the present disclosure may be applied to various terminal entities, and this implementation manner of the present disclosure is widely applicable as can be used in a cross-platform and cross-terminal manner.

Based on the foregoing detailed analysis, an implementation manner of the present disclosure further provides an account generating system.

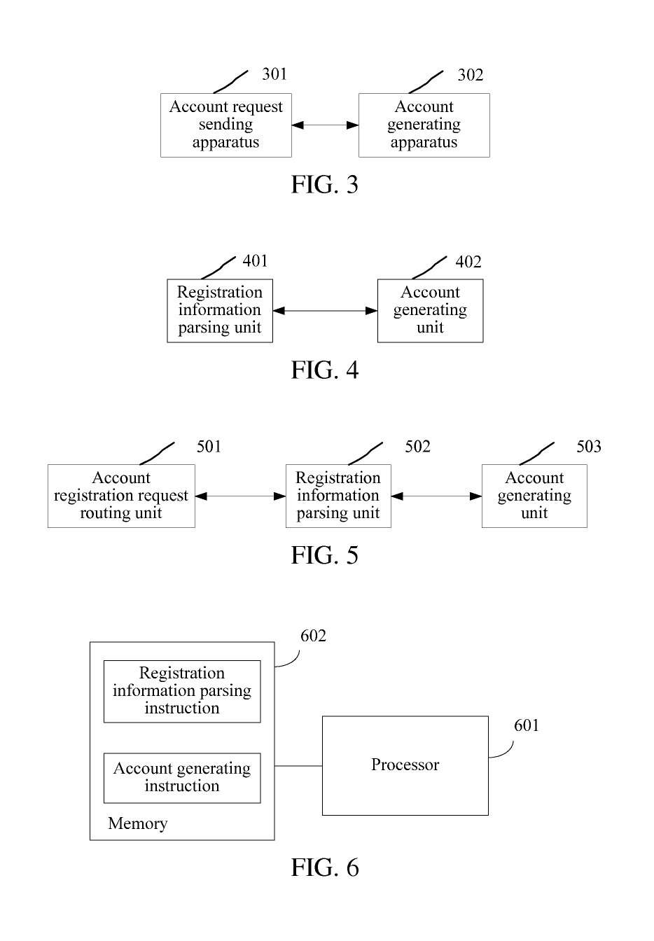

FIG. 3 is a structural diagram of an account generating system according to an implementation manner of the present disclosure. As shown in FIG. 3, the system includes an account request sending apparatus 301 and an account generating apparatus 302,

where:

the account request sending apparatus 301 is configured to send an account registration request that includes registration information to the account generating apparatus 302; and

the account generating apparatus 302 is configured to receive the account registration request that includes the registration information, route the account registration request to one of at least two account service processes, obtain, by using an account service process that receives the account registration request, the registration information by parsing the account registration request, and generate an account that corresponds to the registration information.

Specifically, the account generating apparatus 302 is further configured to store the registration information in a local file, and generate, by using a number of the local file and a storage offset, which is in the local file, of the registration information, the account that corresponds to the registration information.

In an implementation manner, the account generating apparatus 302 is configured to route the account registration request to one of the at least two account service processes in a polling manner; or preset a priority of each account service process in the at least two account service processes, and route, according to an order of the priorities, the account registration request to one of the at least two account service processes.

Preferably, at least two local files are saved in the account service process that receives the account registration request. The account generating apparatus 302 is configured to determine whether storage capacity of a current local file reaches a preset storage upper limit, if yes, store the registration information in a local file that corresponds to a next local file number, and if not, store the registration information in a local file that corresponds to a current local file number.

In an implementation manner, the account generating apparatus 302 is configured to preset a first composition position and a second composition position of an account; fill the first composition position with the number of the local file, and fill the second composition position with the storage offset, which is in the local file, of the registration information; and combine the first composition position after filling and the second composition position after filling into the account that corresponds to the registration information.

In an implementation manner, the account generating apparatus 302 is further configured to store, in a cache of the account service process, the registration information and the account that corresponds to the registration information; and determine whether an account reading request is received, and if yes, in response to the account reading request, extract the account that corresponds to the registration information and/or the registration information from the cache of the account service process, and send the account that corresponds to the registration information and/or the registration information.

Based on the foregoing detailed analysis, an implementation manner of the present disclosure further provides an account generating apparatus.

FIG. 4 is a schematic structural diagram of a first account generating apparatus according to an implementation manner of the present disclosure. As shown in FIG. 4, the apparatus includes: a registration information parsing unit 401 and an account generating unit 402, where

the registration information parsing unit 401 is configured to obtain, by using one account service process that receives an account registration request in at least two account service processes, registration information by parsing the account registration request; and

the account generating unit 402 is configured to generate an account that corresponds to the registration information.

FIG. 5 is a schematic structural diagram of a second account generating apparatus according to an implementation manner of the present disclosure.

As shown in FIG. 5, the apparatus includes: an account registration request routing unit 501, a registration information parsing unit 502, and an account generating unit 503, where:

the account registration request routing unit 501 is configured to receive an account registration request that includes registration information, and route the account registration request to one of at least two account service processes;

the registration information parsing unit 502 is configured to obtain, by using an account service process that receives the account registration request, the registration information by parsing the account registration request, and store the registration information in a local file; and

the account generating unit 503 is configured to generate, by using a number of the local file and a storage offset, which is in the local file, of the registration information, an account that corresponds to the registration information.

In an implementation manner, the account registration request routing unit 501 is configured to route the account registration request to one of the at least two account service processes in a polling manner; or preset a priority of each account service process in the at least two account service processes, and route, according to an order of the priorities, the account registration request to one of the at least two account service processes.

Preferably, at least two local files are saved in the account service process that receives the account registration request. The registration information parsing unit 502 is configured to determine whether storage capacity of a current local file reaches a preset storage upper limit, if yes, store the registration information in a local file that corresponds to a next local file number, and if not, store the registration information in a local file that corresponds to a current local file number.

In an implementation manner, the account generating unit 503 is configured to preset a first composition position and a second composition position of an account; fill the first composition position with the number of the local file, and fill the second composition position with the storage offset, which is in the local file, of the registration information; and combine the first composition position after filling and the second composition position after filling into the account that corresponds to the registration information.

Preferably, the account generating apparatus 503 is configured to store, in a cache of the account service process, the registration information and the account that corresponds to the registration information; and determine whether an account reading request is received, and if yes, in response to the account reading request, extract the account that corresponds to the registration information and/or the registration information from the cache of the account service process, and send the account that corresponds to the registration information and/or the registration information.

The apparatuses shown in FIG. 4 and FIG. 5 may be integrated into various hardware entities of a communications network. For example, the account generating apparatus may be integrated into a device such as an account management server, a functional mobile phone, a smartphone, a palmtop computer, a personal computer (PC), a tablet computer, or a personal digital assistant (PDA).

FIG. 6 is a schematic structural diagram of a third account generating apparatus according to an implementation manner of the present disclosure.

As shown in FIG. 6, the apparatus includes: a processor 601 and a memory 602, where

the memory 602 is configured to store a registration information parsing instruction and an account generating instruction; and

the processor 601 communicates with the memory 602, performs a registration information parsing instruction in the memory 602, and is configured to obtain, by using one account service process that receives an account registration request in at least two account service processes, registration information by parsing the account registration request; and

performs the account generating instruction, and is configured to generate an account that corresponds to the registration information.

The processor 601 further performs the registration information parsing instruction and the account generating instruction, and is configured to perform further operations of the foregoing registration information parsing unit 502 and account generating unit 503. The memory 602 is further configured to store an account registration request routing instruction. The processor 601 further performs the account registration request routing instruction, and is configured to perform operations of the foregoing account registration request routing unit 501.

In fact, the account generating apparatus provided in this implementation manner of the present disclosure may be specifically implemented in various manners. For example, the account generating apparatus may be compiled, by using an application program interface that complies with a certain standards, into a plug-in that is installed in an account management server, or may be encapsulated into an application program for a user to download for use. When compiled into a plug-in, the account generating apparatus may be implemented in various plug-in forms such as ocx, dll, and cab. The account generating apparatus provided in this implementation manner of the present disclosure may also be implemented by using a specific technology, such as a Flash plug-in technology, a RealPlayer plug-in technology, an MMS plug-in technology, an M account I staff plug-in technology, or an ActiveX plug-in technology.

The account generating method provided in this implementation manner of the present disclosure may be stored in various storage media in an instruction storage manner or an instruction set storage manner. These storage media include but are not limited to: a floppy disk, an optical disc, a DVD, a hard disk, a flash drive, a USB flash disk, a CF card, an SD card, an MMC card, an SM card, a memory stick, and an xD card.

In addition, the account generating method provided in this implementation manner of the present disclosure may also be applied to a storage medium based on a flash drive (Nand flash), such as a USB flash disk, a CF card, an SD card, an SDHC card, an MMC card, an SM card, a memory stick, and an xD card.

To sum up, in the implementation manners of the present disclosure, an account registration request that includes registration information is received, and the account registration request is routed to one of at least two account service processes; the account service process that receives the account registration request obtains the registration information by parsing the account registration request, stores the registration information in a local file, and generates, by using a number of the local file and a storage offset, which is in the local file, of the registration information, an account that corresponds to the registration information. As can be seen, after the implementation manners of the present disclosure are applied, instead of enabling a single account allocation subsystem to be in charge of allocating accounts, multiple (at least two) account service processes used for account generation are set; in this way, even though an account service process breaks down, other account service processes can continue to provide an account generating service for a user without being affected. Therefore, an entire account registration service is not stopped, and such an account generating manner in this implementation manner of the present disclosure significantly improves account management stability.

In addition, the implementation manners of the present disclosure are simply designed, account service processes are independent of each other, and after a process or machine breaks down, a registration service can still be provided for a user by using other processes or machines; therefore, the implementation manners of the present disclosure further improve availability of account management. In addition, from the perspective of either devices or operation and maintenance, an operation cost of this implementation manner is relatively low.

Moreover, this implementation manner of the present disclosure may be applied to various terminal entities, and this implementation manner of the present disclosure is widely applicable as can be used in a cross-platform and cross-terminal manner.

The foregoing descriptions are merely preferred embodiments of the present invention, but are not intended to limit the protection scope of the present disclosure. Any modification, equivalent replacement, or improvement made within the spirit and principle of the present disclosure shall fall within the protection scope of the present disclosure.

What is claimed is:

1. (canceled)

2. An account generating method, comprising:
receiving, by one of at least two account service processes, an account registration request that comprises registration information; and
obtaining, by the account service process that receives the account registration request, the registration information by parsing the account registration request, and generating an account that corresponds to the registration information;
storing the registration information in a local file, wherein
the generating an account that corresponds to the registration information comprises:
generating, by using a number of the local file and a storage offset, which is in the local file, of the registration information, an account that corresponds to the registration information.

3. The method according to claim 2, further comprising a step of routing the account registration request to one of the at least two account service processes.

4. The account generating method according to claim 3, wherein the routing the account registration request to one of the at least two account service processes comprises:
routing the account registration request to one of the at least two account service processes in a polling manner; or
presetting a priority of each account service process in the at least two account service processes, and routing, according to an order of the priorities, the account registration request to one of the at least two account service processes.

5. The account generating method according to claim 2, wherein at least two local files are saved in the account service process that receives the account registration request; and
the storing the registration information in a local file comprises:
determining whether storage capacity of a current local file reaches a preset storage upper limit, if yes, storing the registration information in a local file that corresponds to a next local file number, and if not, storing the registration information in a local file that corresponds to a current local file number.

6. The account generating method according to claim 2, wherein the generating, by using a number of the local file and a storage offset, which is in the local file, of the registration information, an account that corresponds to the registration information comprises:
presetting a first composition position and a second composition position of an account;
filling the first composition position with the number of the local file, and filling the second composition position with the storage offset, which is in the local file, of the registration information; and
combining the first composition position after filling and the second composition position after filling into the account that corresponds to the registration information.

7. (canceled)

8. An account generating apparatus, comprising: a registration information parsing unit and an account generating unit:
the registration information parsing unit being configured to obtain, by using one account service process that receives an account registration request in at least two account service processes, registration information by parsing the account registration request; and
the account generating unit being configured to generate an account that corresponds to the registration information; wherein
the registration information parsing unit is further configured to store the registration information in a local file; and
the account generating unit is further configured to generate, by using a number of the local file and a storage offset, which is in the local file, of the registration information, the account that corresponds to the registration information.

9. The account generating apparatus according to claim 8, further comprising:
an account registration request routing unit, configured to receive the account registration request, and route the account registration request to one of the at least two account service processes.

10. The account generating apparatus according to claim 9, wherein
the account registration request routing unit is configured to route the account registration request to one of the at least two account service processes in a polling manner; or preset a priority of each account service process in the at least two account service processes, and route, according to an order of the priorities, the account registration request to one of the at least two account service processes.

11. The account generating apparatus according to claim 8, wherein at least two local files are saved in the account service process that receives the account registration request; and
the registration information parsing unit is further configured to determine whether storage capacity of a current local file reaches a preset storage upper limit, if yes, store the registration information in a local file that corresponds to a next local file number, and if not, store the registration information in a local file that corresponds to a current local file number.

12. The account generating apparatus according to claim 8, wherein
an account generating unit is configured to preset a first composition position and a second composition position of an account; fill the first composition position with the number of the local file, and fill the second composition position with the storage offset, which is in the local file, of the registration information; and combine the first composition position after filling and the second composition position after filling into the account that corresponds to the registration information.

13. (canceled)

14. An account generating system, comprising an account request sending apparatus and an account generating apparatus:
the account request sending apparatus being configured to send an account registration request that comprises registration information to the account generating apparatus; and
the account generating apparatus being configured to receive the account registration request that comprises the registration information, route the account registration request to one of at least two account service processes, obtain, by using an account service process that receives the account registration request, the registration information by parsing the account registration request, and generate an account that corresponds to the registration information; wherein
the account generating apparatus is further configured to store the registration information in a local file, and generate, by using a number of the local file and a storage offset, which is in the local file, of the registration information, the account that corresponds to the registration information
